(19) United States
(12) Patent Application Publication
(10) Pub. No.: US 2020/0264296 A1
(43) Pub. Date: Aug. 20, 2020

(54) VESSEL RENDEZVOUS DETECTION

(71) Applicant: Vulcan Technologies LLC, Seattle, WA (US)

(72) Inventors: Patrick Dunagan, Seattle, WA (US); David Martin Moore, Seattle, WA (US); Jeremy Kyle Bensley, Whitesboro, TX (US)

(21) Appl. No.: 16/277,819

(22) Filed: Feb. 15, 2019

(51) Int. Cl. G01S 13/76

(52) U.S. Cl. CPC G01S 13/765

(57) ABSTRACT

A vessel rendezvous system obtains position data from each vessel of a plurality of vessels operating within a navigable area. Using the position data from each vessel, the vessel rendezvous system determines that a first vessel was engaged in an action with a second vessel within the navigable area. In response to this determination, the vessel rendezvous system provides an indication that the first vessel and the second vessel were engaged in the action within the navigable area.

### BACKGROUND

Maritime navigation often relies on each vessel in open water to provide heading, course, and speed information to ensure safe passage and prevent accidents in the open water. However, some vessels will forego providing this information in order to conceal any illicit or otherwise unauthorized actions, such as illegal fishing operations that may threaten local wildlife. For instance, a vessel may disable, for a period of time, its transponder to conceal its heading, course, and speed information while it rendezvous with another vessel. Detecting such rendezvous can be difficult, as the concealed information can make it difficult to determine a vessel's actions during the period of concealment. This can prevent any remedial actions from being taken to address any possible illicit or otherwise unauthorized action on the part of the vessels involved in such a rendezvous.

### BRIEF DESCRIPTION OF THE DRAWINGS

Various techniques will be described with reference to the drawings, in which:

FIG. 1 shows an illustrative example of a system in which various embodiments can be implemented;

FIG. 2 shows an illustrative example of a system in which a vessel rendezvous system processes transponder data and environment data of navigable areas in order to identify any rendezvous among vessels navigating through the navigable areas in accordance with at least one embodiment;

FIG. 3 shows an illustrative example of an interface in which a detected rendezvous is presented within a pre-defined target area in a map area window in accordance with at least one embodiment;

FIG. 4 shows an illustrative example of an interface in which details related to a detected rendezvous are presented in an activity alert detail window in accordance with at least one embodiment;

FIG. 5 shows an illustrative example of a process for detecting a rendezvous among a set of vessels based on segment data for each vessel in accordance with at least one embodiment;

FIG. 6 shows an illustrative example of a process for performing a radius search in vicinity of a detected rendezvous to identify a set of vessels possibly engaged in the rendezvous in accordance with at least one embodiment; and

FIG. 7 illustrates a system in which various embodiments can be implemented.

### DETAILED DESCRIPTION

Techniques described and suggested herein relate to a system for detecting rendezvous among vessels based on tracking data for each vessel over time. In an example, a vessel rendezvous system obtains transponder data for a set of vessels and environment data related to the navigable areas which the set of vessels may traverse or otherwise operate in. The transponder data may be obtained via an automatic tracking system such as the automatic identification system (AIS), satellite AIS (S-AIS), and the like. Each vessel may transmit, as transponder data, heading information (e.g., cardinal direction in which the bow of a vessel is pointed, etc.), course information (e.g., cardinal direction in which the vessel is to be steered, etc.), and the speed of the vessel over the navigable area. The environment data may include weather data, depth or elevation within the navigable areas, present conditions in the navigable areas (e.g., wind speed, wave height, etc.), proximity to ports, harbors, offshore drilling platforms, and the like. In an example, the vessel rendezvous system generates, for each vessel, a set of travel segments based on transponder data obtained for the vessel over a period of time. These travel segments may be used to determine the travel profile of a vessel over a navigable area over a period of time.

In an example, the vessel rendezvous system uses the set of travel segments for each vessel to determine whether a vessel has engaged in a rendezvous within a navigable area. For instance, the vessel rendezvous system may use historical segment data for a vessel and the newly computed segment data for the vessel using its latest transponder data and the environment data obtained during the time period in which the transponder data was collected to identify any anomalous behavior of the vessel. If there is anomalous behavior detected, the vessel rendezvous system may determine whether this anomalous behavior coincides with known rendezvous characteristics. For example, if the anomalous behavior corresponds with the vessel coming to a halt in a navigable area for a period of time and this action does not correspond with the historical profile (e.g., vessel engaged in fishing, refueling, etc.) for the vessel or with a reported issue with the vessel (e.g., mechanical failure, etc.), the vessel rendezvous system may determine that the vessel was engaged, during this period of anomalous behavior, in a rendezvous with another vessel.

In an example, if the vessel rendezvous system detects that a vessel has been engaged in a rendezvous, the vessel rendezvous system processes the transponder data of other vessels within the same navigable area and the environment data for the navigable area to determine which vessels may have been engaged in the rendezvous with the vessel. For instance, the vessel rendezvous system may perform a radius search in the vicinity of the segment corresponding to the rendezvous to identify which vessels within the navigable area have segment data that coincide with the rendezvous segment within the radius of the rendezvous segment. In an example, if any vessels within the navigable area disabled their AIS such that no transponder data is obtained over a period of time, the vessel rendezvous system may use transponder data for these vessels obtained prior to the disabling of their AIS and after the AIS was re-activated to interpolate possible segment data for these vessels during the outage. Using the interpolated segments, the vessel rendezvous system may identify the vessels that may have participated in the rendezvous with the vessel identified by the vessel rendezvous system as having engaged in the rendezvous.

In an example, the vessel rendezvous system generates, in response to detection of a rendezvous involving a first vessel, an alert that may be transmitted to interested entities. For instance, the vessel rendezvous system may transmit the alert to a maritime entity responsible for the enforcement of maritime law and for the protection of life and property at sea. The vessel rendezvous system may provide these entities with an interface, through which the entities can be presented with a graphical representation of the rendezvous, the first vessel identified as being engaged in the rendezvous, and an ordering of the candidate vessels that may have been engaged in the rendezvous with the first vessel. In an example, the vessel rendezvous system may apply a score to each candidate vessel that may serve as an indication of the likelihood that the candidate vessel was engaged in the rendezvous. Thus, based on the score assigned to each candidate vessel, an entity may determine, through the interface, which candidate vessel was most likely engaged in the rendezvous with the first vessel. Through the interface, the entity may evaluate the characteristic profiles of the vessels and determine what action to perform in response to the alert.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages. For instance, because the vessel rendezvous system can interpolate segment data for any vessel, including vessels that disable their transponders to obscure their location over a period of time, the vessel rendezvous system can determine the likely location of these vessels over any period of time. This may make it easier for an entity to determine the actions taken of a vessel while its transponder has been disabled or otherwise no transponder data is received for the vessel. As another example, because the vessel rendezvous system generates and uses segment data for each vessel along a navigable area, the vessel rendezvous system may generate a characteristic profile for each vessel that may make it easier for the vessel rendezvous system to detect anomalous behavior over time and reduce the rate of false positive identification of a suspicious rendezvous for a set of vessels.

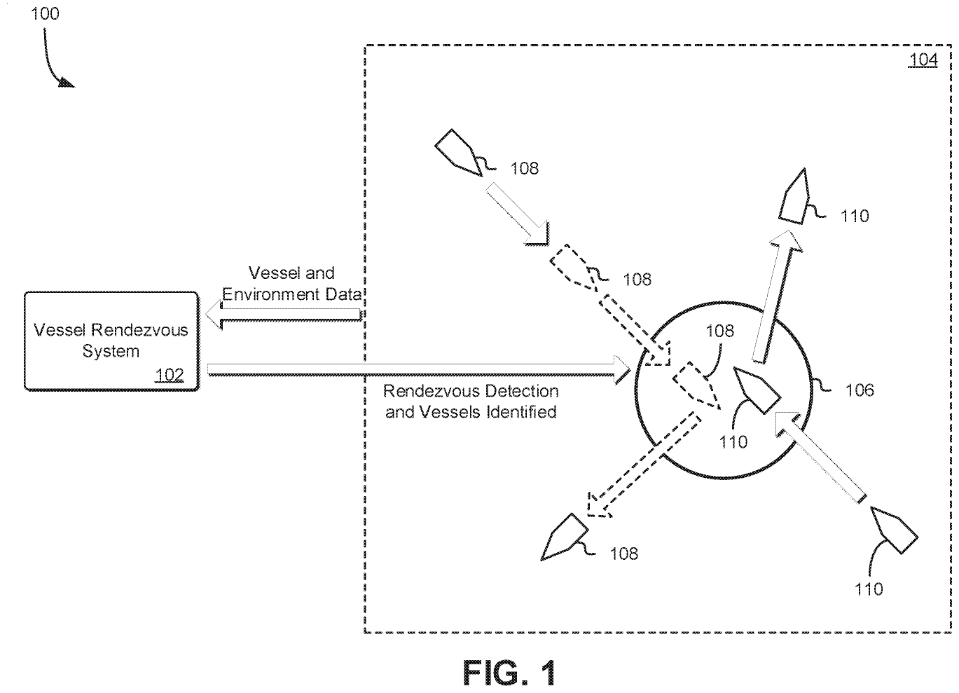

FIG. 1 shows an illustrative example of a system 100 in which various embodiments can be implemented. In the system 100, a vessel rendezvous system 102 obtains data corresponding to a set of vessels 108, 110 operating within a navigable area 104 that may be used to determine whether any of the set of vessels 108, 110 have engaged in a rendezvous 106 within the navigable area 104. The vessel rendezvous system 102 may comprise a collection of computing resources that collectively operate to monitor vessel activity within navigable areas, such as navigable area 104, and to identify any nefarious or otherwise suspicious activity within these navigable areas. Information generated by the vessel rendezvous system 102 via monitoring of vessel activity within navigable areas may be made available to other maritime entities, such as those responsible for the enforcement of applicable laws within the navigable areas and for the protection of life and property within these navigable areas.

In an embodiment, the vessel rendezvous system 102 obtains transponder data from each vessel 108, 110 within a navigable area 104 via AIS or S-AIS. Each AIS system may comprise a very high frequency (VHF) transmitter, a set of VHF time-division multiple access (TDMA) receivers, a VHF digital selective calling (DSC) receiver, and standard marine electronic communications links to display and sensor systems. Position and timing information may be derived from an integral or extended global navigation satellite system (e.g., Global Positioning System (GPS), etc.) receiver. Information broadcast via AIS or S-AIS may be obtained by the vessel rendezvous system 102 through various communications channels between the vessels 108, 110 and the vessel rendezvous system 102. While AIS and S-AIS are utilized extensively throughout the present disclosure for the purpose of illustration, other transponder-based monitoring systems, such as the Vessel Monitoring System (VMS), and other monitoring systems that do not rely on transponder data may be used to track vessels within a navigable area and to obtain transponder data (from transponder-based monitoring systems) and other vessel data (from other monitoring systems) that may be used to determine whether a rendezvous has occurred. The transponder data obtained by the vessel rendezvous system 102 may include heading information for the vessel, the course and speed of the vessel in the navigable area 104, the rate of turn for the vessel, the angle of heel, pitch and roll, and destination and estimated time of arrival information for the vessel.

The vessel rendezvous system 102 may also obtain environment data related to each of the navigable areas it is tasked with monitoring, including navigable area 104. The environment data may include the real-time weather conditions within the navigable area 104, weather forecasts for the navigable area 104, the depth of navigable area 104, the wave height, wave period, and wave spectrum data within the navigable area 104, the water temperature within the navigable area 104, plankton and other wildlife counts within the navigable area 104, and the like. The environment data may be used by the vessel rendezvous system 102 to identify the potential actions that may be taken by vessels 108, 110 in the navigable area 104 in response to the conditions within the navigable area 104. For instance, if the environment data indicates significant wave turbulence within the navigable area 104, the vessel rendezvous system 102 may determine that vessels 108, 110 may operate at a lower speed or assume a particular posture within the navigable area 104 to mitigate the effects of the wave turbulence on the vessels 108, 110. As another example, the environment data may be used to identify locations within the navigable area 104 that may be conducive to fishing operations. Thus, the vessel rendezvous system 102 may determine that an action of a fishing vessel within such locations are within the normal operations of the fishing vessel.

In an embodiment, the vessel rendezvous system 102 uses the transponder data from each vessel 108, 110 and the environment data for the navigable area 104 to generate segment data for each vessel 108, 110. The segment data may comprise transponder data collected at a first location within the navigable area 104 and transponder data collected at a second location within the navigable area 104 at a time after collection of the transponder data at the first location. These two data points (at the first location and the second location) may correspond to consecutive transponder responses obtained by the vessel rendezvous system 102 from a vessel 108, 110. The segment data may thus include various segments generated using consecutive transponder responses from a vessel 108, 110 within the navigable area 104 and may result in a mapping of vessel movements within the navigable area 104 over a period of time. Using the segment data for each vessel 108, 110 and the environment data for the navigable area 104 for the time during which the segment data was generated, the vessel rendezvous system 102 may determine whether a rendezvous 106 within the navigable area 104 has occurred.

In an embodiment, the vessel rendezvous system 102 utilizes machine learning techniques, such as supervised learning techniques to determine whether a rendezvous 106 has occurred within the navigable area 104. A machine learning system may use the segment data for a vessel 108, 110 and for other vessels operating within the navigable area 104, along with the environment data obtained for the navigable area 104 over time, to build a machine learning model that can be used to detect a rendezvous for a particular vessel based on the segment data for the vessel and the environment data collected during the time the segment data was generated. In this example embodiment, the segment data and the environment data can be fed into a machine learning system and a classification algorithm to build a model that clusters segment data into activity categories. In this example embodiment, input data to train a machine learning model such as, the segment data for a particular vessel, historical segment data for other vessels and for the particular vessel operating within the navigable area 104 over time, the environment data collected during a period of time for which the segment data was collected, and other information that may be pertinent to identifying an activity of a vessel may be used. The other information may include information related to activities commonly performed in the navigable area 104 (e.g., fishing, refueling, etc.). In an embodiment using supervised learning, the input data can also include indications of whether detection of a rendezvous was correct for a given vessel. For example, a vessel's analyzed behavior based on the actions made by the vessel with regard to engaging in a rendezvous, and the like can be used to infer whether a rendezvous determination was correct for the vessel. A machine learning system may, at any time, utilize one or more sample vectors to perform one or more simulations to determine whether the functions utilized by the vessel rendezvous system 102 to determine whether a rendezvous has occurred are producing correct and accurate results and/or to refine the one or more functions utilized by the vessel rendezvous system 102 to produce correct and accurate results. For instance, during initialization of the machine learning system, the vessel rendezvous system 102 may provide the machine learning system with one or more sample vectors and analytical results (e.g., desired outcomes) that should be obtained based at least in part on these one or more sample vectors. The machine learning system, based at least in part on this exercise, may adjust the functions utilized by the vessel rendezvous system 102 to analyze the vectors corresponding to activity associated with a rendezvous within the navigable area 104.

The machine learning system may receive input from one or more analysts employed by an authority that administers the vessel rendezvous system 102 to analyze the results from the one or more analyses performed by vessel rendezvous system 102 through use of the one or more functions described above. For instance, an analyst may review the segment data for a particular vessel, historical segment data for the vessel and other vessels operating in the navigable area 104, environment data, and other information from other sources, and the one or more vectors generated by the vessel rendezvous system 102 to determine whether the particular vessel was engaged in a rendezvous 106 within the navigable area 104 at a given time. The analyst may provide his/her input for use in refining the model used to classify vector input as corresponding to any of the aforementioned activities or to another activity altogether. The vector of measurements corresponding to the review performed by the analyst and the desired outcome corresponding to the analyst's input may be used by the machine learning system to update the model used to classify vector inputs. Such may be performed by multiple analysts and/or using multiple vector inputs to provide the machine learning system a sufficient number of sample vector inputs and desired outputs. The machine learning system may adjust the one or more models used by the vessel rendezvous system 102 to increase the likelihood that the desired result is obtained in future analyses.

The model used to classify measurement vectors may vary in accordance with various embodiments. For example, in some embodiments, support vector machine techniques are used to classify regions in Euclidean space as indicative of a rendezvous 106 within the navigable area 104 that is within the normal course of operations for a vessel (e.g., refueling, coordinated fishing activities, etc.), indicative of a rendezvous 106 within the navigable area 104 that is not within the normal course of operation for a vessel, or indicative of a pause in the travel of a vessel for a purpose other than a rendezvous with another vessel. This may be used so that measurements are classified in accordance with the region in which the measurement vectors fall. In yet another embodiment, the machine learning system can utilize decision tree learning to determine a decision (classification, regression) tree used to classify vector input indicative of a routine rendezvous with another vessel, indicative of an anomalous rendezvous with another vessel, indicative of a pause in travel for a purpose other than a rendezvous with another vessel, or of normal travel through the navigable area 104 without any significant pause. As a fictitious illustrative example, if a minimum requirement established by the vessel rendezvous system 102 for classifying a segment for a particular vessel as being indicative of a rendezvous is that the vessel remained stationary in a location within the navigable area 104 that has not been historically used for legitimate activities (e.g., fishing, refueling, etc.) and for a period of time that is greater than a particular threshold, the machine learning may result in a decision tree that, at least in part, bifurcates based on vector components indicating whether the amount of time during which the vessel was stationary is greater than a threshold amount of time and whether the location is utilized by other vessels for legitimate purposes. If the input indicates that the vessel has been stationary for a period of time greater than the threshold and that the location is not one in which vessels become stationary for a purpose other than for rendezvous, the one or more functions (decision trees) would, in this example, provide a result that the vessel was engaged in a rendezvous at this location for the period of time during which the vessel was stationary. Thus, the machine learning algorithm may adjust the one or more functions if these one or more functions do not indicate that the vessel was engaged in a rendezvous at this location.

In an embodiment, if the vessel rendezvous system 102 detects that a vessel 110 was engaged in a rendezvous 106 within the navigable area 104, the vessel rendezvous system 102 evaluates the segment data for other vessels, including vessel 108, operating within the navigable area 104 during the rendezvous 106 to determine which vessels may have been engaged in the rendezvous 106 with vessel 110. For example, the vessel rendezvous system 102 may extend, from the location of the rendezvous 106, a search radius usable to identify any vessels that traversed the area within the search radius during the rendezvous 106. The vessel rendezvous system 102 may evaluate the segment data for each other vessel, including vessel 108, during the rendezvous 106 to determine whether any of these other vessels traversed the area within the search radius. If any of these other vessels traversed the area within the search radius during the rendezvous 106, the vessel rendezvous system 102 may determine the amount of time spent by each of the identified vessels within the search radius in relation to the duration of the rendezvous 106. Further, the vessel rendezvous system 102 may use the segment data for each of the identified vessels to determine the proximity of each of these vessels to the vessel 110 known to have engaged in the rendezvous 106.

In an embodiment, the segment data used to detect that the vessel 110 was engaged in the rendezvous 106 can be generated based on transponder data and other vessel data generated using one transponder-based monitoring system while the segment data for vessel 108 and any other vessel can be generated based on transponder data and other vessel data generated using a different transponder-based monitoring system. For example, the data used to generate the segment data for vessel 110 may be based on AIS transponder data while the data used to generate the segment data for vessel 108 may be based on VMS, another transponder-based monitoring system, or a non-transponder-based monitoring system (e.g., satellite imagery, synthetic aperture radar (SAR) readings, radio-frequency (RF) mapping, etc.).

In an embodiment, the vessel rendezvous system 102 calculates a score for each vessel identified as having potentially engaged in the rendezvous 106 with the vessel 110 identified as having been engaged in the rendezvous 106. The score may be calculated based on the length of time during which a vessel remained within the search radius during the rendezvous 106, the proximity of the vessel to the vessel 110 identified as having engaged in the rendezvous 106, the disparity between the profile of the vessel and its presence near the rendezvous site (e.g., a fishing vessel entering the search radius is deemed unusual based on historical data, etc.), the change in heading of the vessel within the search radius, and the change in heading of the vessel prior to and after the suspected rendezvous (e.g., an indication that the vessel may have traveled outside of its original heading to engage in the rendezvous with vessel 110 and reversed its heading after the rendezvous). For example, a vessel deemed to have been within the search area for a period of time that greatly overlaps the period of time of the rendezvous 106, was within close proximity to the vessel 110, and is not known to traverse this particular region of the navigable area 104 may be assigned a higher score than a vessel that remained in the search area for a short period of time, did not come in close proximity to the vessel 110, and is historically known to traverse the search area.

In some instances, the vessel rendezvous system 102 may determine that a vessel, such as vessel 108, has failed to provide transponder data for a period of time. This may be indicative of an attempt by the vessel 108 to conceal its location and heading/course information for a period of time. If the vessel rendezvous system 102 determines that a vessel 108 has failed to provide transponder data for a period of time, the vessel rendezvous system 102 may use transponder data obtained prior to the data gap and transponder data obtained after the data gap to interpolate the segment data during the time period. This interpolated segment data may be used by the vessel rendezvous system 102 to determine whether the vessel 108 engaged in the rendezvous 106 with the vessel 110. For example, through use of the interpolated segment data, the vessel rendezvous system 102 may estimate the amount of time that the vessel 108 was present within the search radius of the rendezvous 106, whether the vessel 108 came into proximity of the vessel 110, and whether this path taken by the vessel 108 coincides with the historical behavior of the vessel 108 through the navigable area 104. In an embodiment, an indication that a vessel concealed its location through disabling of its transponder can serve as a factor that can be used to increase the score used to determine the probability of the vessel having been engaged in a rendezvous 106 with vessel 110. For example, a vessel deemed to have been within the search area for a period of time that greatly overlaps the period of time of the rendezvous 106, was within close proximity to the vessel 110, is not known to traverse this particular region of the navigable area 104, and is deemed to have disabled its transponder for a time that overlaps with at least a portion of the period of time of the rendezvous 106 may be assigned a higher score than a vessel with similar factors except that it continued to transmit transponder data regularly to the vessel rendezvous system 102.

In an embodiment, if the vessel rendezvous system 102 detects that a vessel 110 has engaged in a rendezvous 106 and has identified a set of vessels, including vessel 108, that may have potentially been engaged in the rendezvous 106 with vessel 110, the vessel rendezvous system 102 transmits an alert to an entity responsible for the enforcement of applicable law within the navigable area 104 and for the protection of life and property within the navigable area 104. For instance, the vessel rendezvous system 102 may provide, to the entity and other entities responsible for regulation or supervision of the navigable area 104, with an interface to enable these entities to identify any rendezvous occurring within the navigable area 104, the vessels known to have engaged in these rendezvous, and the other vessels that may have engaged in these rendezvous. Through the interface, an entity may be presented with a graphical representation of the rendezvous 106, as well as the vessels 108, 110 engaged in the rendezvous 106. Additionally, through the interface, the vessel rendezvous system 102 may provide a score for each vessel that may have been engaged in a particular rendezvous with another vessel. This may allow the entity utilizing the interface to identify vessels for further investigation.

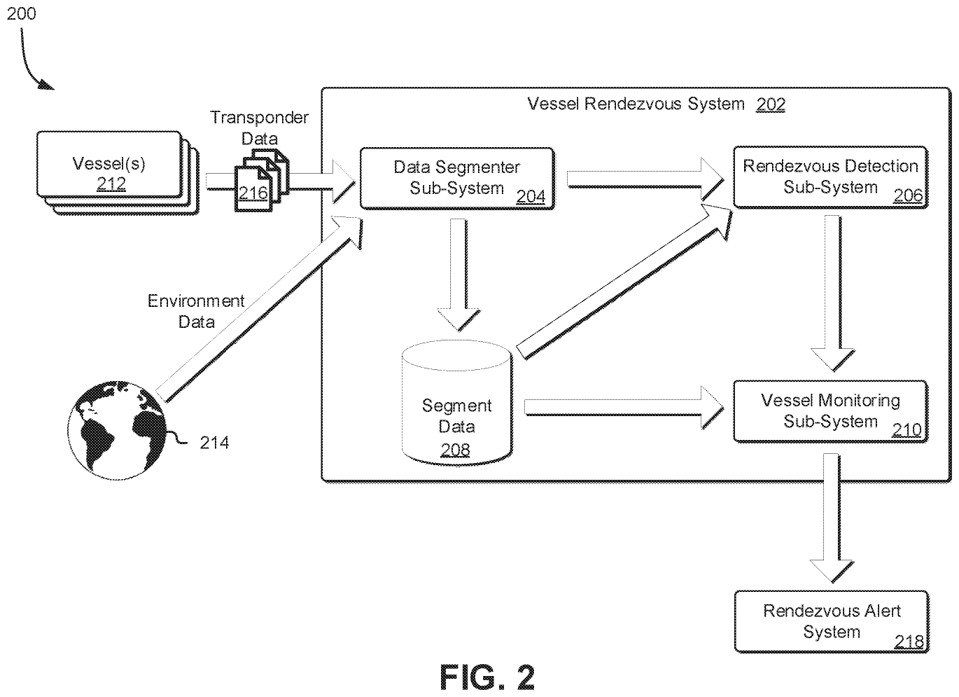

FIG. 2 shows an illustrative example of a system 200 in which a vessel rendezvous system 202 processes transponder data 216 and environment data of navigable areas 214 in order to identify any rendezvous among vessels navigating through the navigable areas 214 in accordance with at least one embodiment. In the system 200, a data segmenter sub-system 204 of the vessel rendezvous system 202 obtains transponder data 216 from a set of vessels 212 operating within navigable areas 214 monitored by the vessel rendezvous system 202. Further, the data segment sub-system 204 may obtain environment data related to the various navigable areas 214 from various sources (e.g., weather services, oceanic and atmospheric services, transportation services, etc.). The data segmenter sub-system 204 is implemented on a computer system or abstraction thereof (such as one or more virtual machines operating via a hypervisor), implemented using hardware and software, and can comprise one or more processors and memory that stores executable instructions whose execution by the one or more processors causes the computer system to perform operations described herein.

The data segmenter sub-system 204 may utilize the transponder data 216 from each vessel of the set of vessels 212 to generate segment data for each vessel. The segment data may specify a segment between each consecutive transponder data point provided by the vessel. For instance, the data segmenter sub-system 204 may organize the obtained transponder data for a particular vessel in chronological order. Between each set of consecutive transponder data points, the data segmenter sub-system 204 may generate a segment that corresponds to the movement of the vessel within a navigable area during the time elapsed between the creations of the two consecutive transponder data points. Thus, the segment data for a particular vessel may comprise a set of segments that collectively detail the path of the vessel through the navigable area. In an embodiment, the data segmenter sub-system 204 aggregates a set of consecutive transponder data points for a vessel into a single segment that can be used to determine whether the vessel engaged in a rendezvous within a navigable area.

In an embodiment, if the data segmenter sub-system 204 determines that a vessel has failed to provide transponder data over a period of time, the data segmenter sub-system 204 interpolates other transponder data obtained from the vessel prior to and subsequent to the failure to generate probable segments for the vessel. Each of these probable segments may be similar in chronological size to other segments generated using actual transponder data from the vessel. The segment data for this vessel may specify that such segments were generated through interpolation due to a gap in transponder data provided by the vessel. The segment data for a particular vessel may also incorporate the environment data corresponding to the characteristics of the navigable area during the period of time in which the vessel was located within the navigable area.

In an embodiment, the data segmenter sub-system 204 stores the segment data for each vessel within a segment data repository 208 of the vessel rendezvous system 202. The segment data repository 208 may comprise a database that includes an entry for each detected vessel within the navigable areas 214 monitored by the vessel rendezvous system 202. Within each entry, the segment data repository 208 may include the segment data collected over time for a particular vessel. Further, the entry may specify any activities recorded related to the particular vessel. This may include previously recorded refueling operations performed within a navigable area, operations related to the specified purpose of the vessel (e.g., fishing activities performed by a fishing vessel, etc.), and the like. Further, the activities recorded within the entry for the particular vessel may include any detected rendezvous in which the vessel was a likely participant. Thus, the segment data repository 208 may be used to store the historical segment data generated for a particular vessel over time and may be used to determine the normal course of operations for a particular vessel and/or to detect any anomalous behavior of the vessel.

The data segmenter sub-system 204 may transmit the newly generated segment data for each vessel 212 to a rendezvous detection sub-system 206, which may use the generated segment data to determine whether a rendezvous likely occurred within any of the navigable areas 214 monitored by the vessel rendezvous system 202. The rendezvous detection sub-system 206 is implemented on a computer system or abstraction thereof (such as one or more virtual machines operating via a hypervisor), implemented using hardware and software, and can comprise one or more processors and memory that stores executable instructions whose execution by the one or more processors causes the computer system to perform operations described herein. In an embodiment, the rendezvous detection sub-system 206 uses the provided segment data for each vessel 212, historical segment data for each vessel 212 from the segment data repository 208, and the applicable environment data for the navigable areas 214 as input to a machine learning algorithm to determine the likelihood of a vessel having been engaged in a rendezvous within any of the navigable areas 214 monitored by the vessel rendezvous system 202.

In an embodiment, if the rendezvous detection sub-system 206 detects a possible rendezvous within a navigable area, the rendezvous detection sub-system 206 calculates a score that can be used to denote the probability that the rendezvous actually occurred. For instance, the score may be based on the length of time that a vessel remained stationary or maintained a low speed within a navigable area, the location where the possible rendezvous occurred, whether the actions taken by the vessel are an aberration from historical actions taken by the vessel within the navigable area, and the like. Additionally, or alternatively, the score may be based on any sudden or rapid movement in a particular direction prior to the rendezvous and any sudden or rapid movement in a different direction subsequent to the rendezvous. Such changes in direction prior to and after a rendezvous may indicate travel to a planned rendezvous location. As an illustrative example, the rendezvous detection sub-system 206 may assign a higher score (e.g., higher probability of a rendezvous) if a vessel remained stationary at a location that the vessel would not normally be present in based on historical data for the vessel within the navigable area. A higher score may also be assigned if the location is not conducive to the normal operations of the vessel. For instance, if the vessel is primarily used for fishing operations and the vessel was found to be stationary in a location that is not conducive to fishing, the rendezvous detection sub-system 206 may assign a higher score to this particular action by the vessel, as this action may be indicative of a rendezvous at that location.

If the rendezvous detection sub-system 206 detects, based on the segment data for a particular vessel, that the particular vessel was engaged in a possible rendezvous within a navigable area, the rendezvous detection sub-system 206 may transmit information related to the possible rendezvous to a vessel monitoring sub-system 210 to identify any other vessels that may have been engaged in the rendezvous with the particular vessel. The vessel monitoring sub-system 210 is implemented on a computer system or abstraction thereof (such as one or more virtual machines operating via a hypervisor), implemented using hardware and software, and can comprise one or more processors and memory that stores executable instructions whose execution by the one or more processors causes the computer system to perform operations described herein. In an embodiment, the vessel monitoring sub-system 210 utilizes the information provided by the rendezvous detection sub-system 206 related to the possible rendezvous to establish a search radius around the location of the possible rendezvous and identify any vessels that may have been within the search radius during the time of the possible rendezvous. To identify these vessels, the vessel monitoring sub-system 210 may evaluate the segment data for the other vessels within the navigable area to identify any vessels having segments that fall within the search radius and coincide with the time period of the possible rendezvous.

In an embodiment, the vessel monitoring sub-system 210 calculates a score for each vessel identified as having potentially engaged in the rendezvous with the vessel identified as having been engaged in the rendezvous. The score may be calculated based on the length of time during which a vessel remained within the search radius during the rendezvous, the proximity of the vessel to the vessel identified as having engaged in the rendezvous, and the disparity between the profile of the vessel and its presence near the rendezvous site (e.g., a fishing vessel entering the search radius is deemed unusual based on historical data, etc.), the change in heading of the vessel within the search radius, and the change in heading of the vessel prior to and after the suspected rendezvous (e.g., an indication that the vessel may have traveled outside of its original heading to engage in the rendezvous with vessel and reversed its heading after the rendezvous). For example, a vessel deemed to have been within the search radius for a period of time that greatly overlaps the period of time of the rendezvous, was within close proximity to the vessel identified as having been engaged in the rendezvous, and is not known to traverse this particular region of the navigable area may be assigned a higher score than a vessel that remained in the search area for a short period of time, did not come in close proximity to the vessel, and is historically known to traverse the area within the search radius.

In some instances, the segment data for a vessel may be incomplete or include one or more gaps that may be indicative of the disabling of the transponder of the vessel. In an embodiment, if the vessel monitoring sub-system 210 determines that segment data for a particular vessel is incomplete or includes one or more gaps, the vessel monitoring sub-system 210 uses the available segment data to perform an interpolation of the segment data and obtain the missing segments. For instance, the vessel monitoring sub-system 210 may use transponder data obtained prior to the data gap and transponder data obtained after the data gap to interpolate the segment data during the time period for which there are no segments available for the vessel. This interpolated segment data may be used by the vessel monitoring sub-system 210 to determine whether the vessel engaged in the rendezvous with the vessel identified by the rendezvous detection sub-system 206 as having been engaged in the possible rendezvous. For example, through use of the interpolated segment data, the vessel monitoring sub-system 210 may estimate the amount of time that the vessel was present within the search radius of the rendezvous, whether the vessel came into proximity of the vessel, and whether this path taken by the vessel coincides with the historical behavior of the vessel through the navigable area.

In an embodiment, an indication that a vessel concealed its location through disabling of its transponder can serve as a factor that can be used to determine the probability of the vessel having been engaged in a rendezvous with the vessel identified by the rendezvous detection sub-system 206. For example, a vessel deemed to have been within the search area for a period of time that greatly overlaps the period of time of the rendezvous, was within close proximity to the vessel, is not known to traverse this particular region of the navigable area, and is deemed to have disabled its transponder for a time that overlaps with at least a portion of the period of time of the rendezvous may be assigned a higher score than a vessel with similar factors except that it continued to transmit transponder data regularly to the vessel rendezvous system. Thus, the disabling of a transponder may serve as an indication of an illicit or otherwise suspicious action, including the engagement of a rendezvous with another vessel.

If the vessel monitoring sub-system 210 identifies a set of vessels that may have potentially been engaged in the rendezvous with vessel identified by the rendezvous detection sub-system 206 as having potentially been engaged in the rendezvous, the vessel monitoring sub-system 210 transmits information related to the possible rendezvous, including vessel information related to the identified vessels that may have been engaged in the possible rendezvous, to a rendezvous alert system 218. The rendezvous alert system 218 is implemented on a computer system or abstraction thereof (such as one or more virtual machines operating via a hypervisor), implemented using hardware and software, and can comprise one or more processors and memory that stores executable instructions whose execution by the one or more processors causes the computer system to perform operations described herein. The rendezvous alert system 218 may be implemented as a system distinct from the vessel rendezvous system 202, as illustrated in FIG. 2, or as a component of the vessel rendezvous system 202.

In an embodiment, the rendezvous alert system 218, in response to the information from the vessel monitoring sub-system 210, transmits an alert to an entity responsible for the enforcement of applicable law within the navigable areas and for the protection of life and property within the navigable areas. For instance, the rendezvous alert system 218 may provide, to the entity and other entities responsible for regulation or supervision of the navigable area, with an interface to enable these entities to identify any possible rendezvous that may have occurred within the navigable area, the vessels known or suspected to have engaged in these rendezvous, and the other vessels that may have engaged in these rendezvous. Through the interface, an entity may select and be presented with a graphical representation of a possible rendezvous, as well as the vessels that may have been engaged in the rendezvous. Additionally, through the interface, the rendezvous alert system 218 may provide a score corresponding to the probability that rendezvous occurred and a score for each vessel corresponding to the probability that the vessel may have been engaged in a particular rendezvous with another vessel. This may allow the entity utilizing the interface to identify vessels for further investigation.

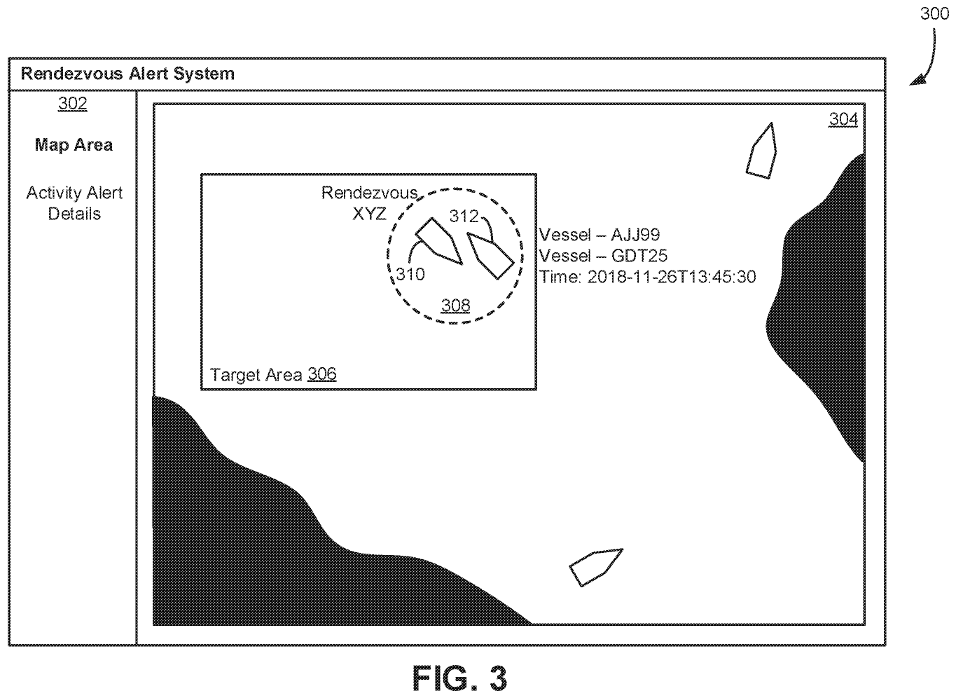

FIG. 3 shows an illustrative example of an interface 300 in which a detected rendezvous 308 is presented within a pre-defined target area 306 in a map area window 304 in accordance with at least one embodiment. As noted above, the rendezvous alert system may provide users with an interface through which these users may receive alerts regarding possible rendezvous that may have occurred within a navigable area. The interface 300 may include a window selection panel 302 through which a user may select to view a particular map area or alert details related to activity, including rendezvous, within a particular map area or a set of map areas. If the user selects, via the window selection panel 302, the map area option, the rendezvous alert system may update the interface 300 to present the user with a map area window 304.

The map area window 304 may include a graphical representation of a particular geographic region that includes a navigable area. For instance, the map area window 304 may be used to illustrate land masses, bodies of water, weather systems, the locations of ports, harbors, offshore drilling platforms, and the like. In an embodiment, the map area window 304 can be utilized by a user of the interface 300 to identify a target area 306 for defining how alerts are generated in response to a detected possible rendezvous within the navigable area. For instance, if the vessel rendezvous system detects that a possible rendezvous has occurred within the user-defined target area 306, the rendezvous alert system may transmit an alert to the user to indicate that a possible rendezvous was detected within its defined target area 306.

In an embodiment, the rendezvous alert system provides, through the map area window 304, a graphical representation of the location where a possible rendezvous may have occurred, such as the graphical representation of rendezvous 308. Through a demonstration of each possible rendezvous that may have occurred within the navigable area represented in the map area window 304, a user may identify any possible rendezvous that may have occurred within the target area 306 defined by the user. The presentation of possible rendezvous through the map area window 304 may be limited based on a time range for possible activity within the navigable area. For instance, the map area window 304 may be used to present possible rendezvous detected within a particular time period. This time period may be changed via the interface 300 to identify other rendezvous that may have occurred at other time periods. The presentation of possible rendezvous through the map area window 304 may also be limited based on matching vessel criteria. These criteria may include, but are not limited to: the country of ownership of the vessels, the type of vessel (e.g., fishing, cargo, passenger, etc.), entity that owns the vessel, length of vessel history for the vessel, dimensions of the vessel (e.g., height, width, etc.), and the like. These vessel criteria may be maintained in a vessel database maintained by the vessel rendezvous system or other entity that may provide vessel information to the vessel rendezvous system.

The graphical representation of a rendezvous 308 may comprise a circle or other shape that may placed around the identified location of the possible rendezvous. Within the graphical representation of the rendezvous 308, the rendezvous alert system may include a graphical representation of the vessels 310, 312 suspected of having engaged in the rendezvous. This may include the vessel 310 identified by the aforementioned rendezvous detection sub-system, based on the segment data for the vessel 310, as potentially having been engaged in a rendezvous. Further, the rendezvous alert system may include the vessel 312 identified by the aforementioned vessel monitoring sub-system as the vessel most likely engaged in the rendezvous with vessel 310. The selection of vessel 312 may be based on the score calculated for the vessel 312. For instance, through the map area window 304, the rendezvous alert system may select the vessel 312 having the highest score or other indicator that the vessel 312 was the vessel most likely engaged in the rendezvous with vessel 310. As noted above, the vessel monitoring sub-system may identify a set of vessels that may have been engaged in the possible rendezvous with the vessel identified by the rendezvous detection sub-system 206. Through the interface 300, the user may select any of these vessels for presentation within the map area window 304.

In an embodiment, the graphical representation of the vessel 310 and the vessel 312 is presented such that a user can readily identify the heading and course of each vessel 310, 312, as well as the distance between the vessels 310, 312 during the period of the possible rendezvous. This may allow a user of the interface 300 to gauge the level of possible interaction among the vessels 310, 312 and any other vessels that may have been engaged in the possible rendezvous with vessel 310. In addition to providing a graphical representation of the vessels 310, 312 within the boundaries of the possible rendezvous 308, the rendezvous alert system, through the map area window 304 may provide identifying information for each vessel 310, 312 suspected of having engaged in the rendezvous 308. This information may include the name of the vessel, the country of origin of the vessel, the Maritime Mobile Service Identity (MMSI) identifier of the vessel, the International Maritime Organization (IMO) identifier of the vessel, the call sign of the vessel, the vessel type (e.g., fishing, fuel, etc.), the owner of the vessel, the control country of the vessel, and the like. Additionally, the rendezvous alert system may indicate, within the map area window 304, the time at which the possible rendezvous occurred. This information may be utilized by a user to further an investigation into the activities of the vessels 310, 312 during the indicated time.

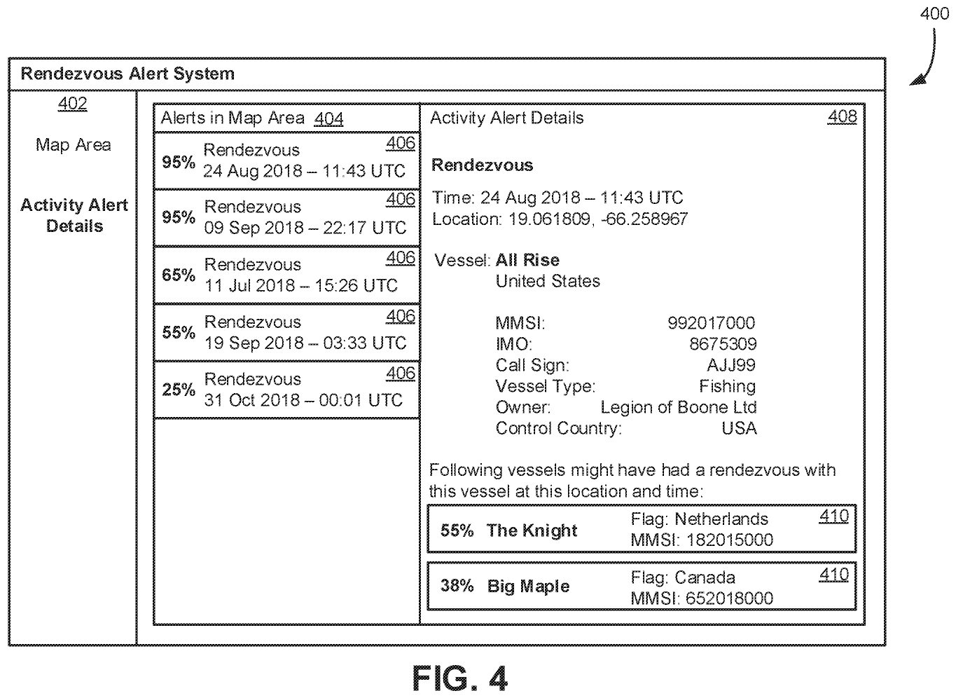

FIG. 4 shows an illustrative example of an interface 400 in which details related to a detected rendezvous are presented in an activity alert detail window 408 in accordance with at least one embodiment. The interface 400 may include similar elements to those of the interface 300 described above in connection with FIG. 3. For instance, the interface 400 may include a window selection panel 402 through which a user may select to view a particular map area or alert details related to activity, including rendezvous, within a particular map area or a set of map areas. If the user selects the activity alert details option from the window selection panel 402, the rendezvous alert system may update the interface 400 to provide an alerts in map area window 404. The alerts in map area window 404 may be used to present the various rendezvous that may have been detected within a particular navigable area over a pre-defined period of time. For instance, within the alerts in map area window 404, the rendezvous alert system may provide an entry 406 corresponding to each possible rendezvous detected within the navigable area over the pre-determined period of time.

Each entry 406 within the alerts in map area window 404 may indicate the type of activity for which was an alert was generated (e.g., rendezvous, illicit activity, etc.). Further, an entry 406 may specify a score that may serve as an indication of the probability of the activity having occurred within the navigable area. For example, as illustrated in FIG. 4, each entry may include a percentage that may indicate the probability that the activity specified in the entry 406 occurred as indicated. This score may be calculated by the rendezvous detection sub-system as described above in connection with FIG. 2. In addition to the score, each entry 406 may specify the date and time at which the activity may have occurred. A user of the interface 400 may sort the various entries 406 specified in the alerts in map area window 404 based on the scores of the activities (e.g., ascending or descending order) or based on the date and time for each entry 406 (e.g., chronological ascending or descending order).

If the user of the interface 400 selects an entry 406 from the alerts in map area window 404, the rendezvous alert system may update the interface 400 to present an activity alert details window 408, which may be used to present the various details related to the possible rendezvous or other detected activity within the navigable area. Through the activity alert details window, the rendezvous alert system may present the type of activity detected, the date and time at which the activity may have occurred, and the geographic location where the activity may have occurred (e.g., latitudinal and longitudinal coordinates, etc.). Further, the rendezvous alert system may present details of the vessel identified by the rendezvous detection sub-system as having been engaged in the rendezvous or other activity. These details may include the name of the vessel, the country of origin of the vessel, the MMSI identifier of the vessel, the IMO identifier of the vessel, the call sign of the vessel, the vessel type (e.g., fishing, fuel, etc.), the owner of the vessel, the control country of the vessel, and the like.

In addition to providing the details of the vessel identified by the rendezvous detection sub-system as having been engaged in the rendezvous or other activity, the rendezvous alert system may present, via the activity alert details window 408, entries 410 corresponding to other vessels that may have been engaged in the rendezvous or other activity with the vessel identified by the rendezvous detection sub-system. Each entry 410 may specify a score corresponding to the probability of the specified vessel having engaged in the rendezvous or other activity with the vessel identified by the rendezvous detection sub-system. As noted above, this score may be calculated by a vessel monitoring sub-system based on the length of time during which a vessel remained within the search radius during the rendezvous, the proximity of the vessel to the vessel identified as having engaged in the rendezvous, and the disparity between the profile of the vessel and its presence near the rendezvous site (e.g., a fishing vessel entering the search radius is deemed unusual based on historical data, etc.). The vessel monitoring sub-system may also consider whether the vessel concealed its position through disabling its transponder for a period of time, including any period of time that may overlap with the rendezvous or other activity, as a factor in determining the score. In addition to the score and the vessel name, an entry 410 may specify the country of origin of the vessel and the MMSI identifier of the vessel. Other information may be presented within each entry 410, including information described above for the original vessel identified via the activity alert details window 408.

In an embodiment, selection of an entry 406 within the alerts in map area window 404 and of an entry 410 in the activity alert details window 408 causes the rendezvous alert system to update the map area window described above in connection with FIG. 3 to graphically represent the selected rendezvous or other activity and the selected vessels that may have engaged in the rendezvous or other activity. Thus, the user may utilize the interface 400 to select which rendezvous or other activities are to be presented via the map area window described above in connection with FIG. 3. In some instances, selection of a rendezvous within the map area window may cause the rendezvous alert system to present the interface 400 and the details of the rendezvous via the alerts in map area window 404 and the activity alert details window 408.

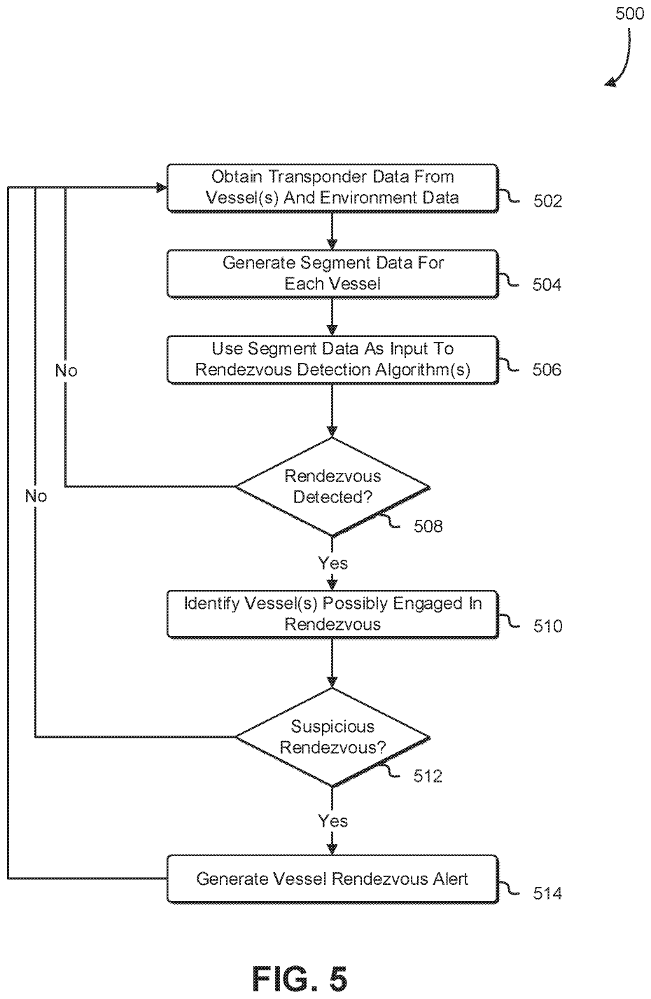

As noted above, a vessel rendezvous system may utilize transponder data from a set of vessels, historical segment data for each of these vessels, and environment data for a navigable area to determine whether a vessel was possibly engaged in a rendezvous with another vessel. If the vessel rendezvous system determines that a rendezvous may have occurred, the vessel rendezvous system may identify any other vessels that may have potentially been engaged in the rendezvous with the vessel. The environment data, as well as other contemporaneous records, may be used to determine whether such a rendezvous was for a legitimate purpose (e.g., cargo transfers, refueling, emergency and rescue, etc.) or for an illicit or otherwise suspicious purpose. Accordingly, FIG. 5 shows an illustrative example of a process 500 for detecting a rendezvous among a set of vessels based on segment data for each vessel in accordance with at least one embodiment. The process 500 may be performed by the aforementioned vessel rendezvous system, which may use the components described above in connection with FIG. 2 to determine whether a rendezvous occurred and identify the vessels that may have been engaged in a rendezvous.

At any time, the vessel rendezvous system may obtain 502 transponder data from a set of vessels operating within a particular navigable area being monitored by the vessel rendezvous system, as well as environment data for the navigable area corresponding to the period of time for collection of the transponder data. The transponder data obtained by the vessel rendezvous system may include heading information for each vessel, the course and speed of each vessel in the navigable area, the rate of turn for each vessel, the angle of heel, pitch and roll, and destination and estimated time of arrival information for each vessel. The environment data may include the real-time weather conditions within the navigable area, weather forecasts for the navigable area, the depth of navigable area, the wave height, wave period, and wave spectrum data within the navigable area, the water temperature within the navigable area, and the like. The environment data may be used by the vessel rendezvous system to identify the potential actions that may be taken by vessels in the navigable area in response to the conditions within the navigable area.

In response to obtaining the transponder data from a set of vessels and the environment data for a particular navigable area, the vessel rendezvous system may generate 504 segment data for each vessel of the set of vessels. The segment data may comprise, for each consecutive pair of transponder data points, transponder data collected at a first location within the navigable area and transponder data collected at a second location within the navigable area at a time after collection of the transponder data at the first location. These two data points (at the first location and the second location) may correspond to consecutive transponder responses obtained by the vessel rendezvous system from a vessel. The segment data may further comprise a series or sequence of two or more vessel positions, as described above. The segment data may thus include various segments generated using consecutive transponder responses from a vessel within the navigable area and may result in a mapping of vessel movements within the navigable area over a period of time.

The vessel rendezvous system may use 506 the generated segment data for each vessel as input to one or more rendezvous detection algorithms to determine 508 whether a rendezvous has been detected. In an embodiment, the vessel rendezvous system, through a rendezvous detection sub-system, uses the segment data for each vessel, historical segment data for each vessel from the segment data repository, and the applicable environment data for the navigable areas as input to a machine learning algorithm to determine the likelihood of a vessel having been engaged in a rendezvous within any of the navigable areas monitored by the vessel rendezvous system. If the vessel rendezvous system detects a possible rendezvous within a navigable area, the vessel rendezvous system may calculate a score that can be used to denote the probability that the rendezvous actually occurred. For instance, the score may be based on the length of time that a vessel remained stationary or maintained a low speed within a navigable area, the location where the possible rendezvous occurred, whether the actions taken by the vessel are an aberration from historical actions taken by the vessel within the navigable area, and the like.

If the vessel rendezvous system determines that a rendezvous did not take place, the vessel rendezvous system may obtain 502 new transponder data from the set of vessels operating in the navigable area, as well as environment data for the navigable area, to determine whether a rendezvous has occurred. However, if the vessel rendezvous system detects that a rendezvous likely occurred within the navigable area, the vessel rendezvous system may identify 510 any other vessels that may have possibly been engaged in the rendezvous with the vessel identified through use of the rendezvous detection algorithms. For instance, the vessel rendezvous system may evaluate the segment data for other vessels operating within the navigable area during the possible rendezvous to determine which vessels may have been engaged in the rendezvous with vessel identified using the rendezvous detection algorithms. For example, the vessel rendezvous system may extend, from the location of the rendezvous, a search radius usable to identify any vessels that traversed the area within the search radius during the rendezvous. The vessel rendezvous system may evaluate the segment data for each other vessel during the rendezvous to determine whether any of these other vessels traversed the area within the search radius. If any of these other vessels traversed the area within the search radius during the rendezvous, the vessel rendezvous system may determine the amount of time spent by each of the identified vessels within the search radius in relation to the duration of the rendezvous. Further, the vessel rendezvous system may use the segment data for each of the identified vessels to determine the proximity of each of these vessels to the vessel known to have engaged in the rendezvous. This information may be used to calculate a score for each vessel identified as having potentially engaged in the rendezvous with the vessel identified via the rendezvous detection algorithms.

The vessel rendezvous system, based on information related to the vessels identified as having potentially been engaged in the rendezvous, may determine 512 whether the possible rendezvous is suspicious in nature. For instance, the vessel rendezvous system may obtain any contemporaneous information from an entity that enforces applicable laws within the navigable area that indicates a legitimate purpose for the rendezvous (e.g., refueling, towing, emergency response and rescue, documented cargo transfers, etc.). Further, the vessel rendezvous system may use the environment data to determine whether the rendezvous may have been related to environmental conditions in the area at the time of the rendezvous. If the rendezvous is deemed to be for a legitimate purpose, the vessel rendezvous system may classify the rendezvous as being legitimate and continue to process transponder and environment data to identify other possible rendezvous in the navigable area.

If the vessel rendezvous system determines that the possible rendezvous is suspicious in nature (e.g., no legitimate purpose is identified for the rendezvous, a vessel disabled its transponder during some or all of the time period for the rendezvous, etc.), the vessel rendezvous system may generate 514 a vessel rendezvous alert. The vessel rendezvous alert may specify information related to the vessel identified via the rendezvous detection algorithms and information related to any other vessel that may have been engaged in the rendezvous. The vessel rendezvous system may transmit this alert to an entity responsible for the enforcement of applicable law within the navigable areas and for the protection of life and property within the navigable areas. For instance, the vessel rendezvous system may provide, to the entity and other entities responsible for regulation or supervision of the navigable area, with an interface to enable these entities to identify any possible rendezvous that may have occurred within the navigable area, the vessels known or suspected to have engaged in these rendezvous, and the other vessels that may have engaged in these rendezvous. In an embodiment, the vessel rendezvous system transmits the vessel rendezvous alert to these entities via an electronic mail message, Short Message Service (SMS) message, Multimedia Messaging Service (MMS) message, push notification, or any other available messaging system or method. Through the interface, an entity may select and be presented with a graphical representation of a possible rendezvous, as well as the vessels that may have been engaged in the rendezvous. Additionally, through the interface, the vessel rendezvous system may provide a score corresponding to the probability that rendezvous occurred and a score for each vessel corresponding to the probability that the vessel may have been engaged in a particular rendezvous with another vessel. This may allow the entity utilizing the interface to identify vessels for further investigation.

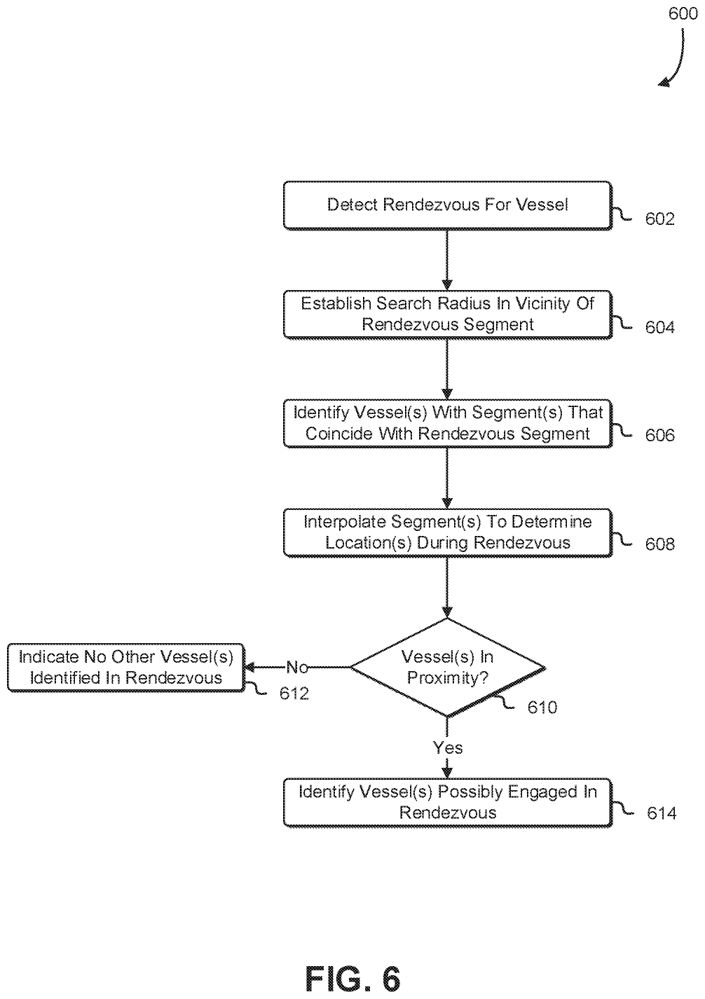

As noted above, if the vessel rendezvous system determines that a rendezvous may have occurred, the vessel rendezvous system may identify any other vessels that may have been engaged in the rendezvous. Additionally, the vessel rendezvous system may perform an interpolation of available segment data to further refine segments corresponding to the time period of the rendezvous. This may serve to identify these other vessels and to calculate the probability of each of these vessels having been engaged in the rendezvous. Accordingly, FIG. 6 shows an illustrative example of a process 600 for performing a radius search in vicinity of a detected rendezvous to identify a set of vessels possibly engaged in the rendezvous in accordance with at least one embodiment. The process 600 may be performed by the aforementioned vessel rendezvous system via a vessel monitoring sub-system, as described above.

At any time, the vessel monitoring sub-system may detect 602 a possible rendezvous for a particular vessel. As described above, the rendezvous detection sub-system may use the generated segment data for each vessel as input to one or more rendezvous detection algorithms to determine whether a rendezvous has been detected. In an embodiment, the rendezvous detection sub-system uses the segment data for each vessel, historical segment data for each vessel from the segment data repository, and the applicable environment data for the navigable areas as input to a machine learning algorithm to determine the likelihood of a vessel having been engaged in a rendezvous within any of the navigable areas monitored by the vessel rendezvous system. If the rendezvous detection sub-system detects that a rendezvous has likely occurred, the rendezvous detection sub-system may provide, to the vessel monitoring sub-system, information related to the possible rendezvous to the vessel monitoring sub-system to identify any other vessels that may have been engaged in the rendezvous with the particular vessel.

In an embodiment, the vessel monitoring sub-system utilizes the information provided by the rendezvous detection sub-system related to the possible rendezvous to establish 604 a search radius around the location of the possible rendezvous and identify 606 any vessels that may have been within the search radius during the time of the possible rendezvous. To identify these vessels, the vessel monitoring sub-system may evaluate the segment data for the other vessels within the navigable area to identify any vessels having segments that fall within the search radius and coincide with the time period of the possible rendezvous. In some instances, the segment data for a vessel may be incomplete or include one or more gaps that may be indicative of the disabling of the transponder of the vessel. In an embodiment, if the vessel monitoring sub-system determines that segment data for a particular vessel is incomplete or includes one or more gaps, the vessel monitoring sub-system uses the available segment data to perform 608 an interpolation of the segment data and obtain the missing segments. For instance, the vessel monitoring sub-system may use transponder data obtained prior to the data gap and transponder data obtained after the data gap to interpolate the segment data during the time period for which there are no segments available for the vessel. This interpolated segment data may be used by the vessel monitoring sub-system to determine whether the vessel engaged in the rendezvous with the vessel identified by the rendezvous detection sub-system as having been engaged in the possible rendezvous. For example, through use of the interpolated segment data, the vessel monitoring sub-system may estimate the amount of time that the vessel was present within the search radius of the rendezvous, whether the vessel came into proximity of the vessel, and whether this path taken by the vessel coincides with the historical behavior of the vessel through the navigable area.

Based on the segment data for each of the identified vessels having segments that coincide with the rendezvous segment or are within the search radius, the vessel monitoring sub-system may determine 610 whether any of the identified vessels were likely in proximity of the vessel identified by the rendezvous detection sub-system during the possible rendezvous. For instance, proximity may be defined based on a threshold distance between the vessels at any time during the possible rendezvous. Thus, based on the segment data for each vessel, the vessel monitoring sub-system may determine whether the distance between the vessels was within the threshold distance. If the vessel monitoring sub-system determines that no vessel was in proximity to the vessel identified by the rendezvous detection sub-system as being engaged in a rendezvous (e.g., no vessel was within the threshold distance of the identified vessel during the rendezvous), the vessel monitoring sub-system may indicate 612 that no other vessels were identified as having been engaged in the rendezvous with the vessel identified by the rendezvous detection sub-system. However, if the vessel monitoring system determines that one or more vessels were in proximity of the vessel identified by the rendezvous detection sub-system, the vessel monitoring system may identify 614 these one or more vessels as having possible been engaged in the rendezvous. As noted above, the vessel monitoring sub-system may assign a score to each vessel, which may serve as an indicator of the probability that the vessel was engaged in the possible rendezvous.

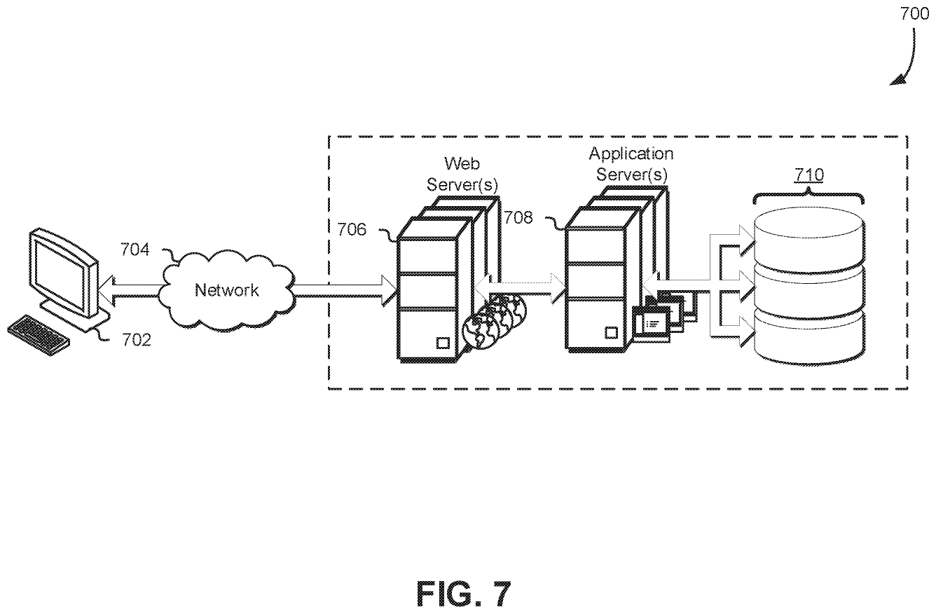

FIG. 7 illustrates aspects of an example system 700 for implementing aspects in accordance with an embodiment. As will be appreciated, although a web-based system is used for purposes of explanation, different systems may be used, as appropriate, to implement various embodiments. In an embodiment, the system includes an electronic client device 702, which includes any appropriate device operable to send and/or receive requests, messages, or information over an appropriate network 704 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 706 for receiving requests and serving content in response thereto, although for other networks an alternative device serving a similar purpose could be used as would be apparent to one of ordinary skill in the art.

In an embodiment, the illustrative system includes at least one application server 708 and a data store 710, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 702 and the application server 708, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 710, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data and user information, which are used to serve content for the production side. The data store also is shown to include a mechanism for storing log data, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 710.

The data store 710, in an embodiment, is operable, through logic associated therewith, to receive instructions from the application server 708 and obtain, update or otherwise process data in response thereto, and the application server 708 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 702. Continuing with this particular example, information for a particular item of interest is viewed in a dedicated page or window of the browser. It should be noted, however, that embodiments of the present disclosure are not necessarily limited to the context of web pages but are more generally applicable to processing requests in general, where the requests are not necessarily requests for content. Example requests include requests to manage and/or interact with computing resources hosted by the system 700 and/or another system, such as for launching, terminating, deleting, modifying, reading, and/or otherwise accessing such computing resources. In an embodiment, the application server 708 passively and/or continuously receives data streams comprising vessel transponder data for a plurality of vessels from data streaming or other sources of such data. The application server 708 may also transmit electronic messages and alerts to users in the event that a rendezvous is detected. Thus, the application server 708 may perform certain operations without need for users to submit requests to the application server 708.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 700, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 7. Thus, the depiction of the system 700 in FIG. 7 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C # or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, Apache Kafka®, Apache Beam, Apache Spark™, and any other server capable of storing, retrieving, and accessing structured or unstructured data. In an embodiment, a database server includes table-based servers, document-based servers, unstructured servers, relational servers, non-relational servers, log-based message queues, event storage systems, or combinations of these and/or other database servers.

In an embodiment, the system includes a variety of data stores and other memory and storage media as discussed above which can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (CPU), graphics processing unit (GPU), and/or tensor processing unit (TPU), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
obtaining, from a fleet of vessels operating within a navigable area, transponder data for each vessel of the fleet of vessels;
determining, based on the transponder data and environment data for the navigable area, that a first vessel from the fleet of vessels was engaged in a rendezvous within the navigable area;
identifying, based on other transponder data for other vessels of the fleet of vessels, a set of second vessels suspected of having been engaged in the rendezvous with the first vessel;
determining, for each second vessel of the set of second vessels, a score indicating whether the second vessel engaged in the rendezvous with the first vessel, resulting in a determination; and
providing an indication that the rendezvous occurred, the indication including the determination.

2. The computer-implemented method of claim 1, wherein the method further comprises:
identifying, based on second transponder data of a vessel of the set of second vessels, a gap in the second transponder data indicative of a disabling of a transponder of the vessel;
performing an interpolation of the second transponder data to obtain additional transponder data; and
using the additional transponder data to determine that the vessel is suspected of having been engaged in the rendezvous.

3. The computer-implemented method of claim 1, wherein the method further comprises:
establishing, from a location of the rendezvous, a search radius within the navigable area; and
identifying the set of second vessels as a result of second transponder data for the set of second vessels corresponding to presence of each second vessel within the search radius during the rendezvous.

4. The computer-implemented method of claim 1, wherein the score is determined based on proximity of the second vessel to the first vessel during the rendezvous, a length of a period of time during which the proximity was maintained, and changes in headings of the first vessel and the second vessel.

5. A system, comprising:
one or more processors; and
memory that stores computer-executable instructions that, if executed, cause the system to:
obtain position data from vessels of a plurality of vessels in an area;
determine based on the position data, that a first vessel of the plurality of vessels engaged in an action with a second vessel of the plurality of vessels; and
provide an indication that the first vessel engaged in the action.

6. The system of claim 5, wherein the position data comprises transponder data transmitted using a transponder-based monitoring system.

7. The system of claim 5, wherein the action is a rendezvous at a location that is conducive to activities unrelated to a profile of the first vessel and to a profile of the second vessel.

8. The system of claim 5, wherein the computer-executable instructions that cause the system to determine that the first vessel engaged in the action with the second vessel further cause the system to:
identify, based on the position data, a location of the action;
establish, from the location, a search radius for identifying other vessels engaged in the action; and
determine that the first vessel and the second vessel engaged in the action as a result of proximity of the first vessel to the second vessel within the search radius during the action.

9. The system of claim 5, wherein the computer-executable instructions that cause the system to determine that the first vessel engaged in the action with the second vessel further cause the system to calculate a score indicating whether the first vessel engaged in the action with the second vessel.

10. The system of claim 5, wherein the computer-executable instructions that cause the system to obtain the position data from the vessels of the plurality of vessels further cause the system to:
identify, based on vessel position data of a vessel of the plurality of vessels, a gap in the vessel position data that is indicative of a disabling of a transponder of the vessel;
perform an interpolation of the vessel position data to obtain additional position data for the vessel; and
use the additional position data to determine whether the vessel engaged in the action.

11. The system of claim 5, wherein the computer-executable instructions that cause the system to determine that the first vessel engaged in the action with the second vessel further cause the system to utilize first position data of the first vessel and second position data of the second vessel as input to a machine learning model configured to determine engagement in the action.

12. The system of claim 5, wherein the indication includes identifying information of the first vessel, information regarding the action, and identifying information of the second vessel suspected of having engaged in the action with the first vessel.

13. A non-transitory computer-readable storage medium having stored thereon executable instructions that, as a result of being executed by one or more processors of a computer system, cause the computer system to at least:
obtain position data from each vessel of a plurality of vessels operating in an area;
determine, based on the position data, that a first vessel of the plurality of vessels engaged in an action in the area;
identify, based on a location and time period of the action and the position data, a second vessel of the plurality of vessels engaged in the action with the first vessel; and
provide an indication that the first vessel engaged in the action.

14. The non-transitory computer-readable storage medium of claim 13, wherein the location is associated with activities unrelated to a profile of the first vessel and to a profile of the second vessel.

15. The non-transitory computer-readable storage medium of claim 13, wherein the instructions that cause the computer system to identify the second vessel engaged in the action with the first vessel further cause the system to:
identify, based on the position data, the location of the action;
establish, from the location, a search radius for identifying other vessels engaged in the action; and
identify the second vessel as a result of proximity of the second vessel to the first vessel within the search radius during the time period of the action.

16. The non-transitory computer-readable storage medium of claim 13, wherein the instructions that cause the computer system to obtain the position data further cause the computer system to:
identify, based on vessel position data of a vessel of the plurality of vessels, a gap in the vessel position data that is indicative of a disabling of a transponder of the vessel;
perform an interpolation of the vessel position data to obtain additional position data for the vessel; and
use the additional position data to determine whether the vessel engaged in the action.

17. The non-transitory computer-readable storage medium of claim 13, wherein the indication includes first identifying information of the first vessel, second identifying information of the second vessel, and information regarding the action.

18. The non-transitory computer-readable storage medium of claim 13, wherein the instructions that cause the computer system to identify the second vessel further cause the system to:
calculate, based on the location and time period of the action and the position data, a score indicating whether the second vessel engaged in the action with the first vessel; and
use the score to determine that the second vessel engaged in the action with first vessel.

19. The non-transitory computer-readable storage medium of claim 13, wherein the position data comprises transponder data transmitted using a transponder-based monitoring system.

20. The non-transitory computer-readable storage medium of claim 13, wherein the instructions that cause the computer system to identify the second vessel engaged in the action with the first vessel further cause the computer system to use first position data of the first vessel, second position data of the second vessel, data that indicates the location, and data that indicated the time period of the action as input to a machine learning model configured to determine engagement in the action.
